(19) United States
(12) Patent Application Publication
(10) Pub. No.: US 2014/0287114 A1
(43) Pub. Date: Sep. 25, 2014

(54) CRYSTALLIZATION RESISTANT FROZEN FOOD PRODUCTS

(71) Applicant: SOLAZYME ROQUETTE NUTRITIONALS, LLC, South San Francisco, CA (US)

(72) Inventors: John Finley, Baton Rouge, LA (US); Rachelle Karpeles, South San Francisco, CA (US)

(21) Appl. No.: 14/353,176

(22) PCT Filed: Oct. 9, 2012
(86) PCT No.: PCT/US12/59338

§ 371 Date: Apr. 21, 2014

Related U.S. Application Data
(60) Provisional application No. 61/550,026, filed on Oct. 21, 2011.
(60) Provisional application No. 61/550,698, filed on Oct. 24, 2011.

(51) Int. Cl. A23L 3/3571; A23L 3/375

(52) U.S. Cl. CPC A23L 3/3571; A23L 3/375
USPC 426/327

(57) ABSTRACT

The present invention relates to method for reformulating a frozen, food product to minimize growth of ice crystals.

### TECHNICAL FIELD

The present invention relates to methods for reformulating a frozen food product to minimize growth of ice crystals.

### BACKGROUND

Large ice crystals are often undesirable in frozen foods and can determine the end point of product shelf-life. Growth of ice crystals during production or storage can degrade the mouthfeel of the product. Such concerns are particularly pointed in the production and storage of frozen dessert products such as ice cream, ice milk, frozen yogurt, sherbet, frozen custard, or gelato, and highly whipped desserts such as mousse. Ice crystals growth is exacerbated by a high water content of the food, as may be found in ice milk or low-fat ice cream. The size of ice crystals is known to increase over time in frozen storage. The problem is exacerbated when the food is subjected to temperature fluctuations or freeze-thaw cycles. Most commonly, this will occur due to the use of a frost-free freeze or when a storage freezer is repeatedly opened; e.g, by consumers repeatedly entering a freezer display case in a grocery store.

Common strategies employed to combat the formation and growth of ice crystals include rapid freezing, controlled frozen storage, better packaging, and the addition of food additives including stabilizers and emulsifiers. Despite these measures, ice crystal formation and growth has remained a major problem in terms of both consumer satisfaction and the economic impact of unusable food products.

### SUMMARY

Illustrative embodiments of the present invention feature a method for reformulating a frozen food product, such as a frozen dessert product, in a manner that reduces the formation or growth of large ice crystals. The method includes identifying a candidate frozen food product having a tendency to form large ice crystals and producing a reformulated frozen food product that includes an amount of microalgal biomass that is sufficient to inhibit the formation or growth of ice crystals.

In various embodiments, the frozen food product may be a frozen dessert such as an ice cream, low-fat ice cream, light ice cream, ice milk, frozen yogurt, sherbet, frozen custard, gelato, frozen mousse, or non-dairy ice cream substitute.

The microalgal biomass may be added in the form of a microalgal flour. The microalgal flour may have an average particle size of from about 2 to 100 micrometers. The reformulated frozen food product may include 2 to 8% algal biomass by weight.

The microalgal biomass may be derived from cells of a species of Chlorella or Prototheca; for example, Chlorella protothecoides or Prototheca moriformis.

In an embodiment, the microalgal biomass may be produced by culturing microalgae in the dark. The culturing may include adding a fixed carbon source.

In an embodiment, the rate of ice crystal growth as measured by the percent change in average ice crystal size is reduced by at least 5% in the reformulated frozen food product as compared to the candidate frozen food product. The rate of ice crystal growth may be measured by cycling the temperature of the product between −10° F. and 40° F.

### BRIEF DESCRIPTION OF THE DRAWINGS

The foregoing features of the invention will be more readily understood by reference to the following detailed description, taken with reference to the accompanying drawing, in which:

FIG. 1 shows a flow diagram depicting a method of producing a reformulated frozen food product in accordance with an embodiment of the present invention.

### DETAILED DESCRIPTION OF EMBODIMENTS OF THE INVENTION

### Definitions

“Biomass” shall mean a material derived from a living organism.

“Frozen food” shall mean a food normally stored below the freezing point of water in the food, thus making it susceptible to loss in value due to ice crystal growth.

A “Frozen dessert” shall mean a frozen food consumed as a dessert, whether naturally or artificially sweetened.

In connection with culturing microalgae, “in the dark” shall mean that microalgae are grown under substantially heterotrophic conditions as opposed to phototrophic conditions. For example, the microalgae may be shielded from light through containment in an opaque fermentation vessel.

A “microalgal flour” shall mean edible, microalgae biomass formulated into a powder consisting of particles that are small enough to allow the powder to be mixed into a food. Although the microalgal flour may retain some water, it is a dry ingredient, as opposed to a suspension of microalgal cells.

“Overrun” is a measure of the air incorporated into a frozen dessert. Overrun is measured as follows: % Overrun=((Final volume of the ice cream−Volume of the ice cream mix used)/Volume of the ice cream mix used)×100.

Illustrative embodiments of the present invention feature a method for reformulating a frozen food product, such as a frozen dessert product, in a manner that reduces the formation or growth of large ice crystals, including those large enough to be noticed by an ordinary consumer, for example, via perception by mouthfeel.

The method includes identifying a candidate frozen feed product having a tendency to form large ice crystals and producing a reformulated frozen food product that includes an amount of microalgal biomass that is sufficient to inhibit the formation or growth of ice crystals.

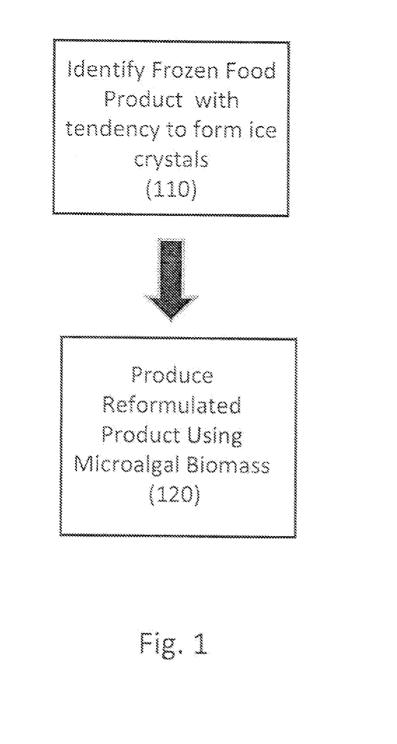

FIG. 1 shows a method for reformulating a frozen food product. First, a frozen food product with a tendency to form ice crystals is identified (step 110). For example, the candidate (and reformulated) food product may be a frozen dessert such as an ice cream, low-fat ice cream, ice milk, frozen yogurt, sherbet, frozen custard, gelato, or non-dairy ice cream substitute. In an embodiment, the frozen food product is one regulated by 21 CFR §135. The product may also be a more complex product that includes a frozen dessert product; e.g., an ice cream cake, ice cream sandwich, ice cream novelty, or corresponding products made with ice cream substitutes or other frozen dessert products.

The product is then reformulated using microalgal biomass (step 120). The microalgal biomass may be in the form of a microalgal flour. The microalgal flour may be made from microalgal biomass using a spray drying process. See, for example, Published U.S. Patent Application 2010/0303989. The flour may comprise intact (unlysed) cells, lysed cells, or a combination thereof (e.g., 10% to 90% intact cells, or preferably 20% to 80% intact cells). The particles that make up the microalgal flour may have a variety of size distributions, but preferably the particles are sized to allow for easy handling of the particles. For example, it may be desirable to have a flowable powder for ease of measurement dispensing, and automation of food processing. In a specific embodiment, the average particle size of the particles is between 2 and 100 micrometers. In an embodiment, the reformulated frozen food product may include 2% to 8% of the microalgal biomass by weight. In preferred embodiments the product includes 3% to 7% or 4% to 6% biomass, by weight.

The microalgal biomass may be derived from cells of a species of chlorella or Prototheca; for example, Chlorella protothecoides or Prototheca moriformis.

The microalgal biomass may be produced by culturing microalgae in the dark. Culturing in the dark may produce a better tasting microalgae. The culturing may include adding a fixed carbon source, such as glucose or sucrose. The fixed carbon source may also include glucose and/or fructose supplemented with glycerol. When sucrose is used as a carbon source, a sucrose invertase may be included.

An ice crystal size of 10 micrometers starts to degrade product quality and ice crystals sizes of 25 micrometers represent an unacceptable product. In embodiments of the invention, the mean or median ice crystal size in the frozen dessert product is less than 25 micrometers or less than 10 micrometers when the product is subjected to the temperature cycling treatment of Example 1. In an embodiment, the rate of ice crystal growth as measured by the percent change in average ice crystal size, as measured by microscopy, is inhibited when compared against a control (non-algal containing) frozen dessert. The rate of crystal growth may be reduced by at least 5% in the reformulated frozen food product as compared to the candidate frozen food product. The rate of ice crystal growth may be measured under the temperature cycling conditions of Example 1. The ice crystal size may be measured by microscopy with computer image analysis to assign a circle equivalent diameter (the diameter of the circle that would have the equivalent area as the object when represented as a 2-dimensional image). In a related embodiment, the mean circle equivalent diameter of the ice crystals is less than 25 microns after the temperature cycling regime of Example 1.

Frozen dessert ice crystals are measured using a microscope inside a freezer box at −10° F. Thin slices of frozen product are placed on a microscope slide and ice crystal size can be measured using computer image analysis.

In an embodiment, two persons or fewer on a tasting panel of 10 people can detect an increase in ice crystals (i.e., an increased perception of ice crystals) in the reformulated product subjected to the freeze thaw cycles of Example 1, as compared to a control product stored at −20° C. for an equal time. In an embodiment, a descriptive analysis sensory panel or an ice cream expert panel cannot detect an increased perception of ice crystals in the reformulated product subject to the freeze-thaw cycling of Example 1, as compared to a control product stored at −20° C. for an equal time.

In embodiments, the frozen dessert product with microalgae exhibits high over-run and excellent ice crystal stability (as discussed above). In embodiments, the overrun is 50%-75%, 75%-100%, 100%-125%, 125%-150%, 150%-175%, 175%-200% or 200% 225%. In embodiments, the shrinkage of the ice cream (i.e., loss of over-run) is less than 10%, 5%, or 2% by volume when subjected to the temperature cycling of Example 1.

### EXAMPLE 1

### Frozen Stability Testing Method

1. 1 pint of frozen products—test and control, are placed into a cycling or non-cycling freezer.

2. The initial temperature and holding temperature are set to −10° F.

3. The freezer defrost cycle is set to defrost 3 times per day for 21 days with the following settings:
Freezer cycle −19° F. to 40° F.
15 minute hold time at each temperature
Ramp rate 5 minutes

### EXAMPLE 2

### The Frozen Dessert and Control, at the End of the 21 Days, and Optionally, Each Week, are Analyzed for One or More of: Sensory Differences, Ice Crystal Sizes by Microscopy, Ice Crystal Mass by Gravimentric Analysis, and Product Shrinkage

### EXAMPLE 3

### Preparing Chocolate Ice Cream With and Without Microalgal Flour

Light Ice Cream with Microalgal Flour.

| | | Percent | Fat |
|---|---|---|---|
| Ingredient | Source/Type | of Total | Percent |
| Milk, Skim | | 65.23% | 0.16% |
| Sugar | C&H/granulated | 13.00% | |
| Algal flour | | 4.00% | 2.20% |
| Cream | 40% Fat | 7.50% | 3.0% |
| cocoa 11% | Gerken's Russet Plus | 3.50% | 0.39% |
| Corn Syrup | 36DE | 3.00% | |
| NFDM, low heat | spray dried extra grade | 2.75% | |
| | low heat nonfat dry | | |
| | milk (from Dairy | | |
| | America) | | |
| GELSTAR ® IC 3548 | FMC (stabilizer and | 0.700% | 0.0049 |
| | emulsifier blend) | | |
| salt | | 0.025% | |
| flavor | | 0.3% | |

Control Ice Cream (No Microalgal Flour)

| | | Percent | Fat |
|---|---|---|---|
| Ingredient | Source/Type | of Total | Percent |
| Milk, Skim | | 62.60% | 0.2% |
| Sugar | C&H/Granulated | 13.00% | |
| Algal flour | | 0.00% | 0.00% |
| Cream | 40% Fat | 13.00% | 5.2% |
| cocoa 11% | Gerken's Russet Plus | 3.50% | 0.39% |
| Corn Syrup | 36DE | 3.00% | |
| NFDM, low heat | spray dried extra grade | 4.25% | |
| | low heat nonfat dry | | |
| | milk (from Dairy | | |
| | America) | | |
| GELSTAR ® IC 3548 | FMC (stabilizer and | 0.600% | |
| | emulsifier blend) | | |
| salt | | 0.050% | |
| flavor | | 0.000% | 0.2% |

Directions:

1. Mix all ingredients in the following order: Algal flour, stabilizer, salt, sugar and cocoa. Set aside.

2. Add corn syrup, skim milk and milk solids. Blend into dry mix. Add cream last.

3. Pasteurize 180° F. for 15 seconds.

4. Homogenize at 180° F./30 bar using the GEA NiroSoavi Panda Homogenizer. Hold mix in double boiler at 150° F. and run through homogenizer.

5. Refrigerate mix

6. Add flavors

7. Run in ice cream machine (Taylor Company). Target is 30-40% overrun

The described embodiments of the invention are intended to be merely exemplary and numerous variations and modifications will be apparent those skilled in the art. All such variations and modifications are intended to be within the scope of the present invention, as defined in the appended claims.

1. A method for producing a food product, the method comprising:
identifying a candidate frozen food product;
producing a reformulated frozen food product including microalgal biomass sufficient to inhibit the formation or growth of ice crystals therein.

2. A method according to claim 1, wherein the frozen food product comprises a frozen dessert.

3. A method according to claim 2, wherein the frozen food product comprises one of ice cream, low-fat ice cream, light ice cream, ice milk, frozen yogurt, sherbet, frozen custard, gelato, or non-dairy ice cream substitute.

4. A method according to claim 1, wherein the microalgal biomass comprises a microalgal flour.

5. A method according to claim 4, wherein the microalgal flour is characterized by an average particle size of 1 to 100 micrometers.

6. A method according to claim 1, wherein the reformulated frozen food product comprises 2% to 8% algal biomass by weight.

7. A method according to claim 1, wherein the microalgal biomass comprises biomass from the genus Chlorella or Prototheca.

8. A method according to claim 7, wherein the biomass comprises biomass of Chlorella protothecoides or Prototheca moriformis.

9. A method according to claim 1, wherein the microalgal biomass is derived from genetically engineered microalgal cells.

10. A method according to claim 1, wherein the microalgal biomass is produced by culturing microalgae in the dark.

11. A method according to claim 10, wherein the culturing includes adding a fixed carbon source.

12. A method according to claim 1, wherein the rate of ice crystal growth as measured by the percent change in mean ice crystal circle equivalent diameter is reduced by at least 5% in the reformulated frozen food product as compared to the candidate frozen food product.

13. A method according to claim 1, wherein two persons or fewer on a tasting panel of 10 people can detect an increased perception of ice crystals in the reformulated product subjected to the freeze thaw cycles of Example 1, as compared to a control product stored at −20° C. for an equal time.

14. A method according to claim 2, wherein the microalgal biomass comprises a microalgal flour.

15. A method according to claim 3, wherein the microalgal biomass comprises a microalgal flour.

16. A method according to claim 2, wherein the reformulated frozen food product comprises 2% to 8% algal biomass by weight.

17. A method according to claim 3, wherein the reformulated frozen food product comprises 2% to 8% algal biomass by weight.

18. A method according to claim 4, wherein the reformulated frozen food product comprises 2% to 8% algal biomass by weight.

19. A method according to claim 5, wherein the reformulated frozen food product comprises 2% to 8% algal biomass by weight.

20. A method according to claim 2, wherein the microalgal biomass comprises biomass from the genus Chlorella or Prototheca.
